(19) United States
(12) Patent Application Publication
(10) Pub. No.: US 2026/0237214 A1
(43) Pub. Date: Aug. 13, 2026

(54) METHOD AND DEVICE FOR DETECTING PASSENGERS GETTING ON AND/OR GETTING OFF A PUBLIC MEANS OF TRANSPORTATION

(71) Applicant: HITACHI RAIL STS S.P.A., NAPOLI (IT)

(72) Inventors: DAVIDE NARDONE, NAPOLI (IT); Ilario LAISO, AVERSA (IT); Carmine STRIGARO, NAPOLI (IT); Paolo SANNINO, NAPOLI (KR)

(21) Appl. No.: 19/154,113

(22) PCT Filed: Jan. 31, 2024
(86) PCT No.: PCT/IB2024/050872

§ 371 Date: Aug. 6, 2025

(30) Foreign Application Priority Data
Feb. 8, 2023 (IT) 102023000002127

(51) Int. Cl. G06V 20/52; G06V 20/59; G06V 40/10

(52) U.S. Cl. CPC G06V 20/52; G06V 20/59; G06V 40/103

(57) ABSTRACT

A method and apparatus for detecting passengers getting on and/or getting off a transport has an acquisition phase, where an image is acquired. The image depicts a door of the transport. In a processing phase, it is determined whether the door is in a closed state or in an open state on the basis of the image. In a detection phase, a passenger getting on or getting off the transport is detected when the door is in the open state.

The present invention relates to a method and a device for detecting passengers getting on and/or getting off a means of transportation, in particular a public means of transportation, where the presence of travelling passengers must be detected for safety reasons and/or for correct application of fare rates.

As is known, public means of transportation such as trains, buses or tram cars are environments where pathogenic agents like flu viruses, the SARS-COV-2 virus, or the like, can spread easily because passengers very often assemble together, thus facilitating airborne pathogen transmission.

In order to limit this phenomenon, it is necessary to employ personnel (e.g. ticket inspectors, drivers when the means of transportation is not moving, etc.) for checking the crowding condition on public means of transportation, so as to make sure that passengers are adequately spaced apart.

However, this task can also be carried out by automatic systems, such as counting systems that, when the means of transportation opens or closes the doors, take care of counting the passengers getting on/off said means of transportation, thus providing information about how many passengers are currently travelling in said means of transportation or staying in a given portion thereof (e.g. a storey of a railway carriage).

According to the state of the art, for such counting systems to operate, they must be connected to one or more of the on-board safety-critical systems of the means of transportation, so that information acquired and verified by said one or more safety-critical systems, e.g. an open state or a closed state of said door, can be shared. This connection requires the counting system to be also certified as a safety-critical system, thus making very costly (in terms of time and money) the installation of a counting system on a fleet of vehicles already in circulation; it must be pointed out, in fact, that those safety-critical systems to which said counting system is connected will have to be certified again.

The present invention aims at solving these and other problems by providing a method for detecting passengers getting on and/or getting off a means of transportation.

Furthermore, the present invention aims at solving these and other problems by providing a device for detecting passengers getting on and/or getting off a means of transportation.

The basic idea of the present invention is to determine, via processing means, whether a door of a means of transportation is in a closed state or in an open state on the basis of at least one image comprising at least one portion depicting at least one portion of a door of said means of transportation, and to detect, via detection means (e.g. people counter sensors, or the like) the passage of at least one passenger getting on or getting off said means of transportation when said door is in the open state.

In this manner, passengers can be effectively counted without the counting systems having to be connected to the safety-critical systems of the means of transportation, such as, for example, railway carriages, tram cars, buses, or the like. It will thus be unnecessary to certify the counting systems and/or to re-certify the on-board safety-critical systems of the vehicle.

Further advantageous features of the present invention are set out in the appended claims.

These features as well as further advantages of the present invention will become more apparent in the light of the following description of a preferred embodiment thereof as shown in the annexed drawings, which are provided herein merely by way of non-limiting example, wherein:

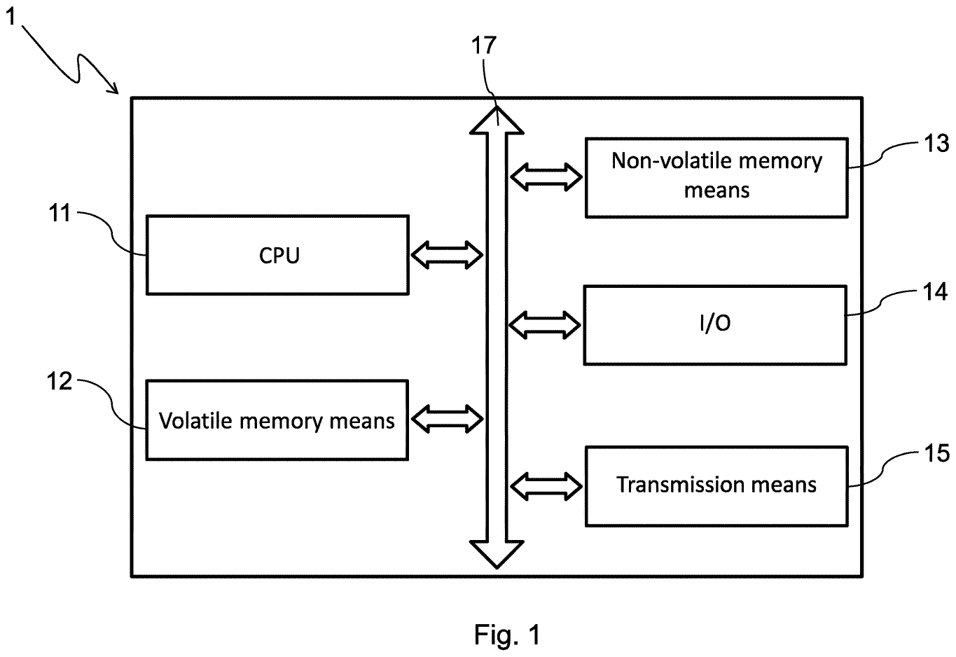

FIG. 1 shows a block diagram representing a device for detecting passengers getting on and/or getting off a means of transportation according to the invention;

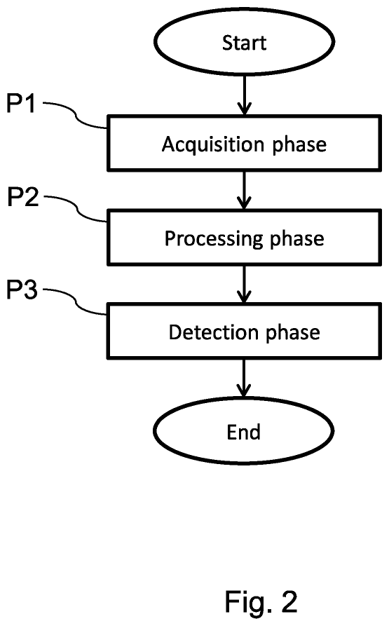

FIG. 2 shows a flow chart representing a method for detecting passengers getting on and/or getting off a means of transportation according to the invention;

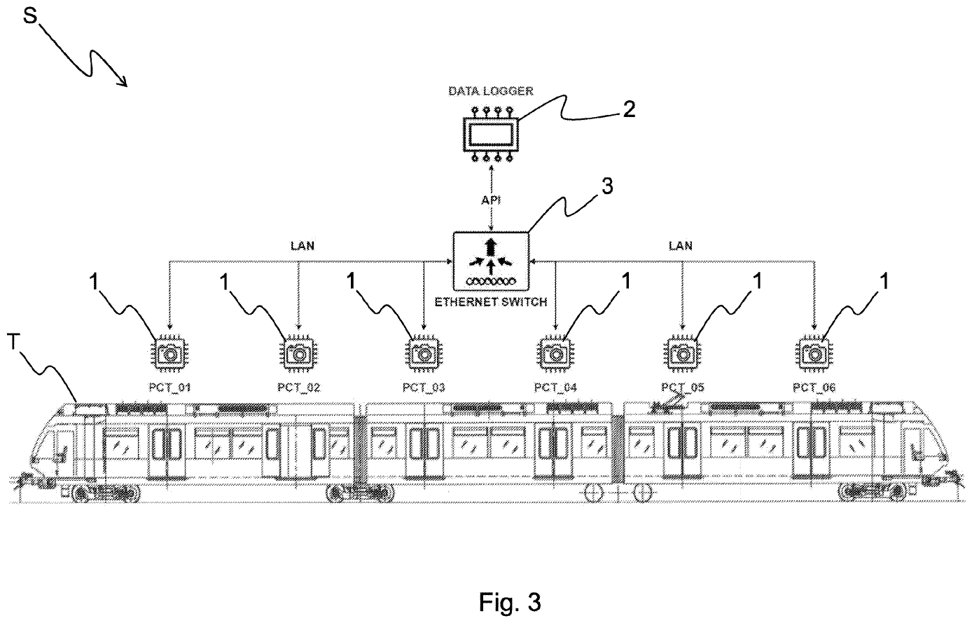

FIG. 3 shows a system comprising a plurality of devices according to the invention.

In this description, any reference to “an embodiment” will indicate that a particular configuration, structure or feature is comprised in at least one embodiment of the invention. Therefore, expressions such as “in an embodiment” and the like, which may be found in different parts of this description, will not necessarily refer to the same embodiment. Moreover, any particular configuration, structure or feature may be combined as deemed appropriate in one or more embodiments. The references below are therefore used only for simplicity's sake, and shall not limit the protection scope or extension of the various embodiments.

With reference to FIG. 1, the following will describe a device for detecting passengers getting on and/or getting off a means of transportation according to the invention, wherein said means of transportation is, preferably, a public means of transportation (e.g. a railway carriage, a tram car, a bus, or the like); said device 1 preferably comprises the following components:
processing means 11, e.g. one or more CPUs, GPUS, FGPAS and/or the like, preferably implementing, via software and/or hardware means, a state classifier trained by inputting thereto one or more training images depicting one or more doors of the means of transportation which are either in an open state or in a closed state, and forcing the output of a datum defining the actual state of the door represented in the training images;
volatile memory means 12, e.g. a random access memory RAM, in signal communication with the processing means 11. When the device 1 is in an operating condition, said volatile memory means 12 store at least one image comprising at least one portion depicting at least one portion of a door of said means of transportation;
non-volatile memory means 13, preferably one or more magnetic disks (hard disks) or a Flash memory or another type of memory, in signal communication with the processing means 11 and with the volatile memory means 12, and wherein said non-volatile memory means 13 contain at least one set of instructions implementing a method for detecting passengers getting on and/or getting off said means of transportation according to the invention. Moreover, said non-volatile memory means 13 may also contain information that makes it possible to configure and/or operate the classifier (e.g. metadata, values representing weights used by the classifier to detect the state of a door, or the like);
input and/or output (I/O) means 14 which can be connected to acquisition means (e.g. CMOS or CCD image sensor, or the like) and to detection means (e.g. people counter sensors, or the like), and which are configured to acquire said at least one image comprising at least one portion depicting at least one portion of said door. Such input/output means 14 may comprise, for example, a USB™, IEEE 1394, RS232, RS485, IEEE 1284 adapter, or the like;
transmission means 15, preferably wired and/or wireless ones (e.g. a network interface such as 803.2 (also known as Ethernet) or 802.11 (also known as WiFi™) or 802.16 (also known as WiMax™) or a data network interface such as GSM/GPRS/UMTS/LTE/5G, TETRA™, LoRa™, XBee™, ZigBee™ or the like), configured for transmitting a signal in which said at least one monitoring datum is encoded to a supervision computer, which will be further described below;
a communication bus 17 allowing information to be exchanged among the processing means 11, the volatile memory means 12, the non-volatile memory means 13, the input/output means 14, and the transmission means 15.

Also with reference to FIG. 2, when the device 1 is in an operating condition, said device 1 executes a set of instructions implementing the method according to the invention, which comprises the following phases:
an acquisition phase P1, wherein at least one image is acquired, via the input means 14, which comprises at least one portion depicting at least one portion of a door of said means of transportation;
a processing phase P2, wherein it is determined, via processing means 11, whether said door is in a closed state or in an open state on the basis of said at least one image;
a detection phase P3, wherein at least one passenger getting on or getting off said means of transportation is detected, via said input means 14, when said door is in the open state, e.g. by activating a counting system for detecting passengers getting on and/or getting off the means of transportation and/or by acquiring signals generated by said counting system.

In this manner, passengers can be effectively counted without the counting systems having to be connected to the safety-critical systems of the means of transportation, such as, for example, railway carriages, tram cars, buses, or the like. Furthermore, many false detections of passengers getting on and/or off will be avoided, since detection will only occur when the doors are open, i.e. when passengers can actually get on/off. It will thus be unnecessary to certify the counting systems and/or to re-certify the on-board safety-critical systems of the vehicle.

It must be pointed out that the phases P1, P2 and P3 of the method according to the invention may also be executed in distinct apparatuses (e.g. each one of the phases P1-P3 may be executed by a single apparatus capable of communicating through a communication network), without however departing from the teachings of the present invention.

It must also be pointed out that the acquisition means and/or the detection means may either be included in the device 1 according to the invention or be provided as separate devices, without however departing from the teachings of the present invention.

The image classifier, e.g. a Support Vector Machine (SVM), a Convolutional Neural Network (CNN), or a Fully Connected Deep Neural Network (FC DNN), is inputted a number of points (pixels) that compose the image portion depicting the portion of the door of the means of transportation whose open or closed state must be detected.

According to the invention, the process preferably comprises also a training phase, wherein, prior to executing the processing phase P2, said classifier is trained by inputting thereto several training images, so that the algorithm can discriminate the desired state, in accordance with the images received during the training phase. In more detail, said training phase is preferably, but not necessarily, carried out by using a workstation comprising a CPU having higher computational power than the processing means 11, wherein said CPU is preferably configured to execute a set of instructions implementing a training algorithm.

In more detail, the method according to the invention preferably comprises also a training phase, wherein, prior to executing the processing phase P2, said neural network is trained in a manner such that, when said neural network is inputted said at least one training image, it will output the desired (second) state datum. This will allow the device 1 to be flexibly adapted in the course of its service life, e.g. should it be moved from one carriage to another, so that the image will show the door of the means of transportation from a different perspective.

In this manner, passengers can be effectively counted without the device 1 having to be connected to the safety-critical systems of the means of transportation. It will thus be unnecessary to certify the counting systems and/or to re-certify the on-board safety-critical systems of the vehicle.

With reference to FIG. 3, the following will describe a system S for detecting passengers getting on and/or getting off a means of transportation, e.g. a train T.

The system S comprises the following elements:
a plurality of devices 1 according to the invention, each one positioned in proximity to at least one of the doors of the means of transportation;
a supervision unit 2 (e.g. a server, an industrial PC, or the like) configured to receive, from said devices 1, data about the open or closed state of doors D comprised in the means of transportation T;
at least one network device (e.g. an Ethernet switch, a router, or the like) allowing the device 1 and the supervision unit 2 to communicate with each other.

As aforementioned, the device 1 preferably comprises the acquisition means, and said device 1 has such a shape that it can be positioned above a door of said means of transportation.

This permits the acquisition means to acquire an image that represents, advantageously, the door throughout its length, and preferably also the striker thereof, so as to ensure a correct detection of the open or closed state of the door; in particular, it will advantageously be possible to detect if the door is not perfectly closed (e.g. because it has tilted due to a broken or loose component, such as a screw, a nut, etc.), thus reducing the probability that a false closed state or a false open state might be detected.

In this manner, passengers can be effectively counted without the device 1 having to be connected to the safety-critical systems of the means of transportation. It will thus be unnecessary to certify the counting systems and/or to re-certify the on-board safety-critical systems of the vehicle.

In more detail, said device 1 has such a shape that it can be arranged in a housing of a lamp, preferably a lamp adapted to illuminate the passageway while passengers are getting on/off.

In this way, the device 1 can advantageously be installed on a means of transportation T that was not originally prearranged for said device 1, so that passengers can be effectively counted without the device 1 having to be connected to the safety-critical systems of the means of transportation, thus avoiding the need for certifying the counting systems.

In combination with the above, the acquisition means preferably comprise a wide-angle lens.

This type of lens, along with the fact that the device 1 is positioned above the door, will permit the acquisition means to acquire an image framing a larger portion of said door, thus further reducing the probability of detecting a false closed state or a false open state, and effectively counting the passengers without the device 1 having to be connected to the safety-critical systems of the means of transportation. It will thus be unnecessary to certify the counting systems and/or to re-certify the on-board safety-critical systems of the vehicle.

Preferably, the supervision unit 2 is also configured to acquire the passage of at least one passenger getting on or getting off the means of transportation through a specific door of the means of transportation T, which passage is detected by the detection means when the device 1, which monitors said door, detects that said door is in the open state. This will allow the supervision unit 2 to determine a total number of people aboard the means of transportation T whereon it has been installed, and optionally to know how many people are present in a particular section of said means of transportation T, e.g. in a particular carriage and/or carriage class, so as to be able to prevent passengers from crowding and/or to detect the presence of any ticketless passengers by comparing booking data with the total number of people determined by the supervision unit 2.

In order to detects such passage, the system S may comprise detection means capable of detecting the passage of one or more persons, e.g. a strain gauge, a capacitive sensor, a radar sensor or the like, preferably positioned near said door or at a point that a user must necessarily cross when getting on or getting off the means of transportation through said door.

As an alternative or in combination with the above, the device 1 preferably comprises said detection means, e.g. an FPGA or the like, configured to detect (during the detection phase P3) the passage of at least one passenger on the basis of said at least one image acquired by the acquisition means. It must be pointed out that the detection means may be included in, or coincide with, said processing means 11.

This further facilitates the installation of the device 1 on a means of transportation not originally prearranged for said device 1, so that effective counting of passengers can be attained without having also to install (dedicated) sensors capable of detecting the passage of people, and without having to connect the devices 1 to the safety-critical systems of the means of transportation. It will thus be unnecessary to certify the counting systems and/or to re-certify the on-board safety-critical systems of the vehicle.

It should be highlighted that the combined use of this feature and of the wide-angle lens is particularly advantageous because the image acquired by the acquisition means will also show, in addition to the door and the striker thereof, one or more passengers who are about to get on/off the means of transportation T, thus permitting the detection of at least one passenger getting on/off said means of transportation; the wide-angle lens, in fact, will keep a passenger within the image for a longer time, thereby increasing the probability that said at least one passenger will be detected.

In addition to the above, the detection means may also be configured to detect (during the detection phase P3) a direction of movement of said at least one passenger on the basis of said at least one image acquired by the acquisition means, i.e. to detect whether said at least one passenger is getting on or getting off said means of transportation (T) (i.e. whether the detected passenger is entering or exiting said means of transportation).

In addition to facilitating the installation of the device 1 on a means of transportation, this also results in the passengers being counted more effectively and in a simpler manner, without requiring the installation of two or more (dedicated) sensors capable of detecting the passage of people, and without having to connect the devices 1 to the safety-critical systems of the means of transportation. It will thus be unnecessary to certify the counting systems and/or to re-certify the on-board safety-critical systems of the vehicle.

Of course, the example described so far may be subject to many variations.

Some of the possible variants of the invention have been described above, but it will be clear to those skilled in the art that other embodiments may also be implemented in practice, wherein several elements may be replaced with other technically equivalent elements. The present invention is not, therefore, limited to the above-described illustrative examples, but may be subject to various modifications, improvements, or replacements of equivalent parts and elements without however departing from the basic inventive idea, as specified in the following claims.

1-11. (canceled)

12. A method for detecting passengers getting on and/or getting off a means of transportation, the method comprising:
an acquisition phase, including acquiring, via an input means, at least one image, which comprises at least one portion depicting at least one portion of a door of said means of transportation;
a processing phase, including determining, via processing means, whether said door is in a closed state or in an open state on a basis of said at least one image,
a detection phase, including detecting at least one passenger getting on or getting off said means of transportation, via said input means, when said door is in the open state.

13. The method according to claim 12, wherein, during the detection phase, a passage of said at least one passenger is detected on the basis of said at least one image acquired during the acquisition phase.

14. The method according to claim 13, wherein, during the detection phase, a direction of movement of said at least one passenger is detected on the basis of said at least one image acquired during the acquisition phase.

15. A device for detecting passengers getting on and/or getting off a means of transportation, comprising:
an input means connectable to:
an acquisition means for acquiring at least one image comprising at least one portion depicting at least one portion of a door of said means of transportation;
a detection means for detecting passengers getting on and/or getting off said means of transportation; the device further comprising:
a processor configured to:
acquire, via the input means, said at least one image;
determine whether said door is in a closed state or in an open state on a basis of said at least one image; and
detect, via the input means, at least one passenger getting on or getting off said means of transportation when said door is in the open state.

16. The device according to claim 15, wherein the device comprises said acquisition means.

17. The device according to claim 16, wherein said device has a shape enabling the device to be positioned above a door of said means of transportation.

18. The device according to claim 16, wherein said device has a shape enabling the device to be located in a housing of a lamp.

19. The device according to claim 16, wherein the acquisition means comprises a wide-angle lens.

20. The device according to claim 19, comprising said detection means, which is configured for detecting, on a basis of said at least one image acquired by the acquisition means, said at least one passenger getting on or getting off said means of transportation.

21. The device according to claim 20, wherein the detection means is also configured for sensing whether said at least one passenger detected is getting on or off said means of transportation.

22. A computer program product which can be loaded into a memory of an electronic computer, and which comprises portions of software code for executing the steps of the method according to claim 1.
